(19) United States
(12) Patent Application Publication
(10) Pub. No.: US 2006/0088149 A1
(43) Pub. Date: Apr. 27, 2006

(54) Set-top-box apparatus and method of providing VoIP service information

(75) Inventor: Je-hun Sung, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/973,269

(22) Filed: Oct. 27, 2004

(51) Int. Cl. H04M 1/56; H04M 15/06

(52) U.S. Cl. 379/142.16; 379/142.01; 379/142.17

(57) ABSTRACT

A set-top-box (STB) apparatus and a method of providing Voice over Internet Protocol (VoIP) service information. The STB apparatus and the method allow a user to quickly and intuitively identify caller information carried in an incoming call signal, regardless of whether a TV is turned on or not, by outputting the caller information detected from the call signal to the TV and internal display unit simultaneously. The STB apparatus includes a VoIP service application that connects to an external network to provide a voice communication service and detects caller information from a call signal received via the external network, and a central processing unit that receives the detected caller information and outputs the same to an external video device and an internal display unit simultaneously.

### BACKGROUND OF THE INVENTION

1. Field of the Invention

The present invention relates to a set-top-box (STB) and a method of providing Voice over Internet Protocol (VoIP) service information, and more particularly, to a STB and a method allowing a user to intuitively and quickly identify information about an incoming call carried in a call signal received through a display unit of the STB, regardless of whether a TV is turned off or not. This is achieved by detecting the information on the incoming call from the call signal received through a VoIP service and transmitting the same to a TV and for a display unit of the STB simultaneously.

2. Description of the Related Art

A STB with an Internet access device enables a TV set to become a user interface to the Internet and connects to the Internet through the Internet access device such as a cable modem or an asymmetric digital subscriber line (ADSL) modem.

The STB then converts digital IP based signals into National Television Standards Committee (NTSC)/Phase Alternation Line (PAL) signals for displaying access to the Internet on a TV output screen through a TV output terminal.

The STB provides users with a variety of Internet-enabled services including web surfing and e-mail services. The services have recently expanded to voice communication services using IP technology instead of a traditional public switched telephone network (PSTN) technology.

The voice communication services can be implemented in VoIP applications that allow voice communications to be carried out over an IP-based Internet. In VoIP service applications, information obtained during voice communications is provided to a TV output screen through a user interface function.

More specifically, referring to FIG. 1, when power is applied to a STB 10, an embedded cable modem operates to connect to a network, which then causes a VoIP service application 11 to operate. When the VoIP service application 11 operates, a call signal is received via the network connected to the cable modem according to a call request from a specific caller.

Then, the VoIP service application 11 detects caller information from the received call signal and forwards the detected caller information to a TV output terminal 12 using a user interface function.

The caller information is then output to a TV 20 through the TV output terminal 12 to be displayed on an output screen of the TV 20.

In such a manner, the caller information displayed on the TV 20 output screen enables a user to identify a caller of the call signal before answering the call signal. However, when the TV 20 is turned off, the information cannot be displayed on the output screen, so it is impossible to identify the caller.

In this case, the user must answer the call signal without viewing the caller information or wait until the TV 20 is turned on in order to display the same information.

To address the above problems, there is a need to develop a method capable of efficiently providing users with caller information on an incoming call signal regardless of whether the TV is turned on or not.

### SUMMARY OF THE INVENTION

According to an aspect of the present invention, a set-top-box (STB) apparatus and method of allowing a user to quickly and intuitively identify information on a caller of an incoming call signal regardless of which a TV is turned off or not by outputting the caller information detected from the call signal to a TV and an internal display unit simultaneously are provided.

In accordance with an aspect of the present invention, upon detection of caller information from a call signal received through a VoIP service application, a central processing unit (CPU) terminates the display of time information on the display unit and forwards the detected user information using a time display function, thereby allowing the caller information to be displayed on the display unit.

In an aspect of the present invention, the CPU forwards the detected caller information to a TV output unit using a user interface function.

According to another aspect of the present invention, a method of forwarding caller information using a time display function includes terminating the display of time information on a display unit using a function current_time_display_stop( ) and forwarding the caller information using a function Time_display_message_receive( ) that displays time information.

In an aspect of the present invention, the set-top-box (STB) for providing VoIP service information includes a VoIP service application that connects to an external network to provide a voice communication service and detects caller information from a call signal received via the external network and a central processing unit (CPU) that receives the detected caller information and outputs the same to an external video device and an internal display unit simultaneously.

In an aspect of the present invention, the CPU displays the caller information to the display unit through the time display function and then outputs the caller information after terminating the time information display on the display unit.

According to an aspect of the present invention, the method of providing VoIP service information according to an embodiment of the present invention includes detecting caller information from a call signal received via a connected external network and receiving the detected caller information in order to output the same to an external video device and an internal display unit simultaneously.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a Voice over Internet Protocol (VoIP) service architecture in a conventional set-top-box (STB);

FIG. 2 is a schematic diagram of a STB capable of providing VoIP service information according to an exemplary embodiment of the present invention;

FIG. 3 is a flowchart illustrating a process of providing VoIP service information according to an exemplary embodiment of the present invention; and

FIG. 4 is a schematic diagram of a VoIP service architecture in a STB according to an exemplary embodiment of the present invention.

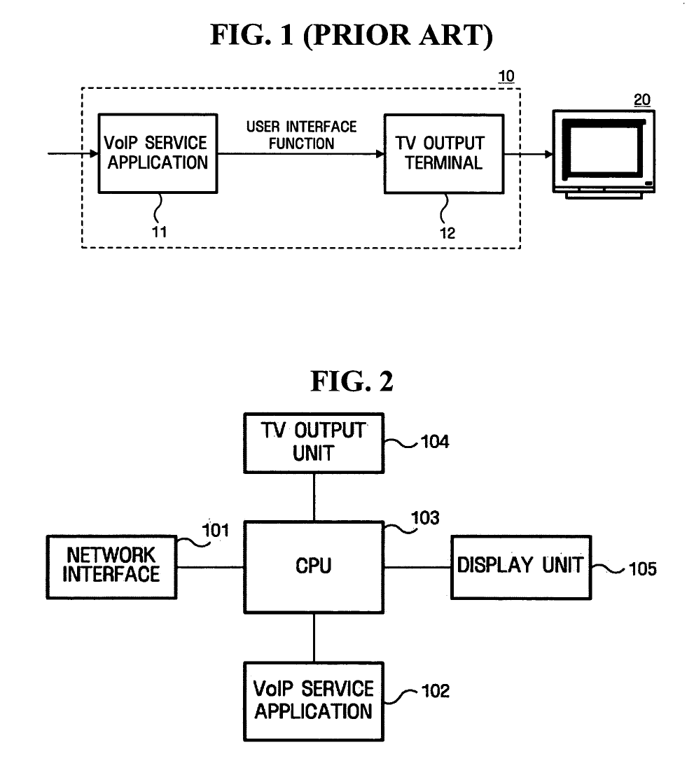

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

A set-top-box (STB) and method of providing Voice over Internet Protocol (VoIP) service information according to an exemplary embodiment of the present invention will now be described in detail with reference to the accompanying drawings.

Embodiments of the present invention are particularly shown and described with reference to an STB apparatus and a method providing VoIP service information by displaying caller information regardless of whether a TV is turned off or not. This can be achieved by forwarding the caller information detected by the VoIP service application to a TV output unit and a display unit simultaneously. However, the caller information may be selectively displayed on a display device as determined by a CPU based on whether a TV is turned off or not. In other words, it will be understood by those of ordinary skill in the art that various changes and equivalents in the method of displaying the caller information may be made therein.

Furthermore, while it is particularly shown and described that a TV is used as an external video device connected to a STB, it will be understood by those of ordinary skill in the art that various changes and equivalents in a display device that is connected to the STB and displays the result obtained as a result of Internet access may be made therein.

FIG. 2 is a schematic diagram of a STB capable of providing VoIP service information according to an exemplary embodiment of the present invention. Referring to FIG. 2, a STB for providing VoIP service information according to an exemplary embodiment of the present invention includes a network interface 101 that is connected to an external network (not shown) according to a voice communication service and performs data transmission and reception for voice communications, a VoIP service application 102 that provides the voice communication service through the network interface 101, a CPU 103 that runs the VoIP service application 102 and controls the overall operations required to provide voice communication service, a TV output unit 104 that outputs predetermined information to a TV according to the control of the CPU 103, and a display unit 105 that displays the predetermined information according to the control of the CPU 103. For example, in a standby mode, the display unit 105 displays a time such that the display unit 105 can serve as a clock, or may display a channel or other information.

The VoIP service application 102 detects caller information from a call signal received through the network interface 101 and forwards the same to the CPU 103 through a user interface function.

The CPU 103 receives the user interface function containing the caller information from the VoIP service application 102 and simultaneously outputs the user interface function to the TV output unit 104 and to the display unit 105 through a time display function. It is understood that the functions of the VoIP service application 102 and the CPU 103 may be combined as a single controller. Additionally, in another aspect the TV output unit 104 and the display unit 105 may be combined such that the display unit performs both sets of functions.

To output the caller information using the time display function, display of time information terminates using a function current_time_display_stop( ), and the caller information is sent using a function Time_display_message_receive( ) that displays the time information. The display unit 105 includes a physical display device such as a liquid crystal display (LCD) positioned in the front of the STB and displays the time information and the caller information received through the time display function according to the control of the CPU 103.

For example, upon detection of an IP address of a caller from a call signal received via the network interface 101 as the caller information, the VoIP service application 102 outputs the IP address of the caller detected through User_Interface_message_receive( ) to the CPU 103.

The CPU 103 outputs the IP address of the caller received through User_interface_message_receive( ) to the TV output unit 104 through User_interface_message_send( ) for displaying the IP address on an output screen of a TV.

At the same time, the CPU 103 terminates the display of temporal information on the display unit 10 using Current_Time_display_stop( ) and displays the caller's IP address received through User_interface_message_receive( ) on the display unit 105 using Time_display_message_receive( ).

All modules of the STB may be configured using hardware or software or a combination of both.

Furthermore, it is obvious to those of ordinary skill in the art that various changes or modifications in the hardware and/or software configuration may be made therein without departing from the embodiments of the present invention.

A method of providing VoIP service information using the above-described STB will now be described in detail with reference to the accompanying drawings.

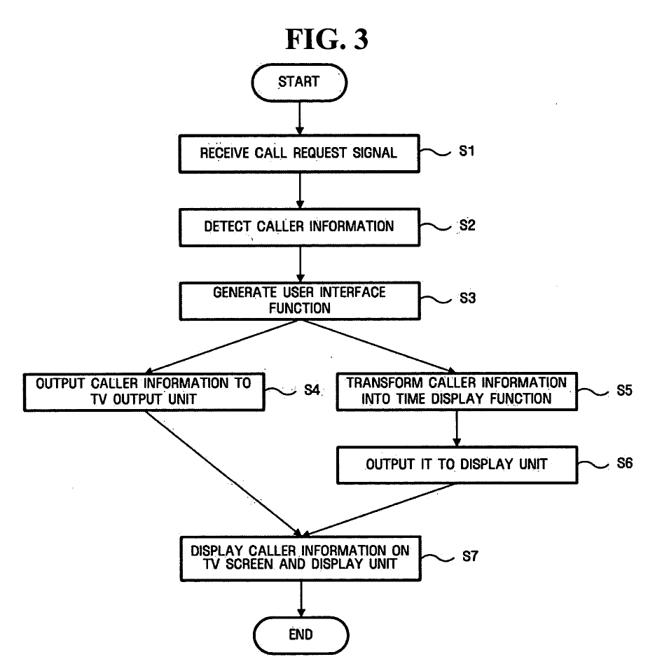

FIG. 3 is a flowchart illustrating a method of providing VoIP service information using the STB. Referring to FIG. 3, first, upon receipt of a call signal through the network interface 101 in operation S1, the VoIP service application 102 detects caller information from the received call signal in operation S2.

In operation S3, the VoIP service application 102 then generates a user interface function containing the detected caller information and outputs the user interface function to the CPU 103. In operation S4, the CPU 103 outputs the caller information received through the user interface function to the TV output unit 104.

At the same time, in operation S5, the CPU 103 generates an interrupt signal current_time_display_stop( ) to terminate the display of time information on the display unit 105 and transforms the received caller information into a time display function Time_display_message_receive( ).

In operation S6, the time display function corresponding to the received caller information is then output to the display unit 105.

In operation S7, when the caller information is forwarded to the TV output unit 104 using the user interface function and to the display unit 105 using the time display function, the caller information is displayed on a TV screen and the display unit 105.

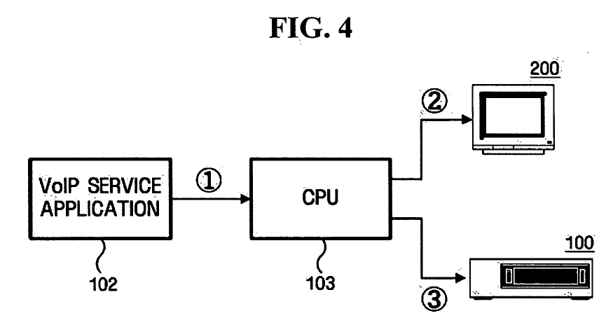

A method of providing VoIP service information using a STB according to an embodiment the present invention will now be described with reference to FIG. 4.

When a specific computer user attempts to place a call using an Internet telephone, a call signal containing an IP address of the user's computer as caller information is transmitted to and received via a cable modem of a STB 100.

The VoIP service application 102 of the STB 100 detects the IP address from the received call signal and forwards the detected caller information to the CPU 103 through a user interface function (path \textcircled{1}).

The CPU 103 transmits the caller information received from the VoIP service application 102 through the user interface function to the TV output unit 104 to display the caller information on an output screen of a TV 200 (path \textcircled{2}).

Simultaneously, the CPU 103 transforms the caller information into a time display function and outputs the time display function to the display unit 105 that then allows the caller information to be displayed on an LCD positioned in the front of the STB 100 (path \textcircled{3}).

In another exemplary embodiment of the present invention, the CPU 103 determines which display device the TV 200 or the STB 100 to display the caller information on, according to whether the TV 200 is turned on or not.

For example, when the TV 200 is turned on, the CPU 103 may output the caller information to the TV output unit 104 according to a rule defined by the user for display on the output screen of the TV 200 or to the TV output unit 104 and the display unit 105 for simultaneous display on the output screen of the TV 200 and the LCD of the STB 100.

Conversely, when the TV 200 is turned off, the CPU 103 outputs the caller information to the display unit 105 for display on the LCD of the STB 100.

In this case, an interface (not shown) is required between the STB 100 and the TV 200 to determine whether the TV 200 is turned on or not.

This process enables a user who uses a voice communication service through the VoIP service application 102 of the STB 100 to view caller information detected from an incoming call signal, regardless of whether a TV is turned on or not.

Therefore, aspects of the present invention allow the user to quickly and intuitively identify caller information contained in an incoming call signal, regardless of whether the TV is turned on or not.

Although the present invention has been described in connection with the exemplary embodiments of the present invention illustrated in the accompanying drawings, it will be readily understood by those skilled in the art that the present invention can be embodied into other specific forms without changing the technical spirit or essential features of the present invention. Therefore, it should be understood that the embodiments are not meant to limit the scope of the present invention, but are merely illustrative of certain aspects. The scope of the present invention is defined by the appended claims rather than the detailed description, and all changes and modifications derived from the meaning and scope of the claims and their equivalents should be construed as falling within the scope of the invention.

What is claimed is:

1. A set-top-box apparatus providing Voice over Internet Protocol (VoIP) service information, comprising:
a VoIP service application that connects to an external network to provide a voice communication service and detects caller information from a call signal received via the external network; and
a central processing unit that receives the detected caller information and outputs the detected caller information to an external video device and an internal display unit simultaneously.

2. The apparatus of claim 1, wherein the central processing unit outputs the caller information to the display unit using a time display function.

3. The apparatus of claim 2, wherein the central processing unit outputs the caller information after terminating the display of time information on the display unit.

4. A method of providing a Voice over Internet Protocol (VoIP) service, comprising:
detecting caller information from a call signal received via a connected external network; and
outputting the detected caller information to an external video device and an internal display unit simultaneously.

5. The method of claim 4, wherein the outputting of the caller information to the external video device and the internal display unit simultaneously comprises:
determining whether the external video device is turned on or not; and
determining whether the external video device or the internal display unit will display the caller information according to the determination of the external video device; and
displaying the caller information on the determined external video device or the internal display unit.

6. The method of claim 4, wherein the outputting of the caller information to the external video device and the internal display unit simultaneously comprises outputting the caller information after terminating the display of time information on the display unit.

7. A method of displaying caller information in a voice over IP system connected to an external network, comprising:
receiving a call signal through the external network;
reading the caller information from the call signal;
detecting whether a first display is turned on;
displaying the caller information on the first display if the first display is turned on; and
displaying the caller information on a second display if the first display is turned off.

8. The method of claim 7, further comprising:
displaying the caller information on the second display when the first display is turned on or off.

9. A TV set top box apparatus, comprising:
a network interface communicating with an external network;
a display interface transmitting display information to display on a screen of the set top box and controlling TV display information to display on a TV screen; and
a controller receiving a call signal from the external network through the network interface according to a voice over Internet Protocol, and detecting caller information corresponding to an originator of the call signal, wherein the controller transmits the caller information to the display interface as display information to display on the screen of the set top box.

10. The apparatus of claim 9, wherein the controller detects whether the TV screen is in an on state after receiving the call signal and if the TV screen is in the on state, the controller transmits the caller information to the display interface as the display information and the TV display information to simultaneously display the caller information on the screen of the set top box and the TV screen.

11. The apparatus of claim 9, wherein the controller transmits the caller information to the display interface as the display information according to a time display function.

12. The apparatus of claim 9, wherein the controller stops displaying the caller information on the display of the set top box after a period of time.

13. The apparatus of claim 9, wherein the controller transmits time information to the display interface for display of a time on the screen of the set top box after a predetermined time of displaying the caller information.

14. A method of displaying caller information in a voice over IP system in a TV set top box connected to an external network, comprising:
displaying caller information detected from a call signal received by the TV set top box from the external network to a user regardless of whether a TV coupled with the TV set top box is turned on.
